(19) United States
(12) Patent Application Publication
(10) Pub. No.: US 2007/0076527 A1
(43) Pub. Date: Apr. 5, 2007

(54) Multi-functional device and method for marine signaling and survival

(76) Inventor: Camille Romano, Miami, FL (US)

Correspondence Address: EZRA SUTTON, P.A., PLAZA 9 BUILDING, 900 ROUTE 9 NORTH, WOODBRIDGE, NJ, 07095, US

(21) Appl. No.: 11/239,760

(22) Filed: Sep. 30, 2005

(51) Int. Cl. H04B 11/00

(52) U.S. Cl. 367/134

(57) ABSTRACT

A multi-function marine emergency communication device for marine signaling and survival including a handheld waterproof housing for holding a plurality of tools; a power source mounted in the housing; and an electronic circuit board mounted in the housing and connected to the power source. A plurality of switches are also mounted in the housing and are connected between the electronic circuit board and the power source. The housing also includes a waterproof spotlight mounted in the housing and a built-in waterproof strobe mounted in the housing, both connected to the electronic circuit board. The housing further includes an acoustical signal generator mounted in the housing and connected to the electronic circuit board; and a telescopic pole and flag retractable into the housing and extendable therefrom; a low battery indicator; a light reflecting surface; and a retractable cutting tool.

### FIELD OF THE INVENTION

The present invention relates to a multi-functional marine communications device and a method for signaling and survival. More particularly, this multi-functional device is a portable, hand-held, emergency marine communication apparatus for use by scuba divers and boaters, either underwater or on the water surface. This marine device provides visual, acoustic, mechanical and electronic tools for communication purposes in various visibility conditions whether on a boat, or on a shoreline during emergency conditions.

### BACKGROUND OF THE INVENTION

While the characteristics and features of the present invention are novel as can be seen from the detailed descriptions, some of the prior art tools, such as GPS radio transmitter, spotlight, mirror, can be found in the marketplace as individual items. Although each of these items provides a useful purpose, alone, they do not cover the many needs one may encounter in scuba diving and boating situations.

On a practical level, it would be too cumbersome to carry all of these items individually. By combining several items into one multi-function device, a convenient, practical device can be used by scuba divers and boaters for routine communication, but also as a life-saving device in-an emergency situation.

A variety of situations exist which require that divers and boaters have some form of communication with each other and with the shoreline. Danger is ever present on the ocean and underwater, and the need for marine communication can vary from casual to life-threatening. Divers and/or boaters may be drifting in currents and need to call attention for rescue. This need for marine communication also exists in non-emergency situations. Divers may get separated from each other underwater and communication by hand signals may no longer be possible.

It can be seen that a need exists for a device which is easily portable by a diver and/or boater for communication by producing sound, light, flag and electronic signals, underwater and on the surface, on the boat or on shore, in different visibility conditions.

### DESCRIPTION OF THE PRIOR ART

Marine emergency signaling and communication devices having various designs, configurations, structures and materials of construction have been disclosed in the prior art. For example, U.S. Pat. Nos. 4,635,242, 4,858,204, 5,010,529; 5,187,691; 5,400;736; 5,652,734; and 6,160,760 all disclose portable signaling devices for generating acoustic signals underwater for communication between divers. These devices can only be used underwater and have only one function, whereas the present invention is multi-function and can be used underwater, on the surface, on boats and on shore. These prior art patents do not disclose or teach the structure and method of use for the multi-functional marine emergency communications device of the present invention.

U.S. Pat. Nos. 5,022,790; 5,062,365; 5,106,236; and 5,302,055 all disclose portable signaling transducers for use only by divers having self-contained underwater breathing apparatus (scuba) to signal to other divers as well as to surface vessels. The devices use high pressure compressed air from the diver's tank to generate sound waves. These devices are mechanical and limited to use with scuba gear, whereas the present invention is electrical and self-contained. These prior art devices use complex valving prone to corrosion due to metallic construction. Also, these devices have only one acoustical function suitable by divers only, whereas the present invention is multi-functional for use by divers and boaters. As such, these prior art patents do not disclose or teach the structure and method of use for the multi-functional marine emergency communications devices of the present invention.

U.S. Pat. Nos. 5,520,486; 6,688,253; and 6,805,071 all disclose safety devices for locating a diver in distress or “man overboard” using deployment of an inflatable or floating object. These prior art patents do not disclose or teach the structure and method of use for the multi-functional marine emergency communications device of the present invention.

U.S. Pat. Nos. 5,099,220; 6,139,170; and 6,473,005 all disclose marine signaling devices consisting of light and sound apparatus for mounting on deck, hull, sidewalls or on the exterior of a vessel. These prior art patents do not disclose or teach the structure and method of use for the multi-functional marine emergency communications device of the present invention.

U.S. Pat. No. 5,295,882 to McDERMOTT discloses a lighting source powered by batteries that make contact by sliding due to gravity forces caused by roll and pitch motions of the ship. This prior art patent does not disclose or teach the structure and method of use for the multi-functional marine emergency communications device of the present invention.

U.S. Pat. Nos. 5,121,366; 5,523,982; 5,907,281; 6,125,080; 6,272,072; and 6,762,678; all disclose underwater signaling systems requiring transmitters and receivers for diver-to-diver communication by means of wireless signals. These are all signal apparatus requiring complex electronics for communication between divers wearing similar apparatus. These devices need two of the apparatus for them to work, which makes the device cost-prohibitive to sports divers. Also, these devices work only underwater, whereas the present invention is simple and versatile. It is usable by divers and boaters. It functions underwater, on the surface, on boats, and on shore. These prior art patents do not disclose or teach the structure and method of use for the multi-functional marine emergency communications device of the present invention.

U.S. Pat. No. 3,469,231 to GEILING et al. discloses a device for underwater communicating and locating. This device has a housing which may be carried on a diver's wrist, a modulated ultrasonic frequency wave transmitter with one or more ultrasonic radiators, which have a far-reaching spherical-shaped characteristic. An ultrasonic frequency receiver is also provided for alternate sending and receiving featuring acoustic or optical indicting elements for receiving signals and for locating a device. This prior art patent does not disclose or teach the structure and method of use for the multi-functional marine emergency communications device of the present invention.

U.S. Pat. No. 4,599,965 to JOHNSON discloses a pivotally mounted diver's signal flag attached to the diver's belt or other portion of his equipment. The supporting mast remains erect and protruding all the time to provide the diver with high visibility. The fact that the mast remains erect and protruding all the time makes it cumbersome, restricting movements of the diver. This prior art patent does not disclose or teach the structure and method of use for the multi-functional marine emergency communications device of the present invention.

U.S. Pat. No. 5,329,873 to TIBALLI discloses an extendable, personal dive flag including tubular segments adapted to be matingly engaged with one another, the segments being extendable in an interlocking position and collapsible to form a bundle. This bundle of collapsed tubular segments is cumbersome, whereas the present invention covers, among multiple other functions, a flag pole telescopically extendable from and retractable into a housing, which results in a more compact, portable device. As such, this prior art patent does not disclose or teach the structure and method of use for the multi-functional marine emergency communications device of the present invention.

U.S. Pat. No. 6,791,490 to KING discloses an integrated dive flag/float and GPS navigation system for scuba divers, and U.S. Pat. No. 6,807,127 to McGREEVER, J R. discloses a scuba diving flag/float assembly used to support a GPS antenna on the surface of the water for use by divers in performing underwater navigation. This prior art patent does not disclose or teach the structure and method of use for the multi-functional marine emergency communications device of the present invention.

U.S. Pat. No. 6,856,578 to MAGINE et al. discloses an underwater alert system including a transmitter assembly carried by a first diver for transmitting a predetermined wireless signal to a receiver assembly, carried by a mask worn by a second diver, for alerting and gaining the attention of the second diver. In a second preferred embodiment, the underwater alert system includes a first transceiver assembly carried by a mask worn by a first diver for communicating a predetermined wireless signal to a second transceiver assembly, carried by a mask worn by a second diver. This permits the first diver and second diver to gain each other's attention. In a third preferred embodiment, the underwater alert system includes a transmitter assembly, carried by a first diver for transmitting a wireless signal, related to data about the first diver's body, equipment, and/or environment, to a receiver assembly, carried by a second diver. This permits the first diver to communicate to the second diver information related to such data. The alert device, such as a visual, an audible or a tactile alert device, generates a predetermined alert, such as light, sound or vibration, respectively, responsive to receiving the predetermined electrical alert attention signal. This prior art patent does not disclose or teach the structure and method of use for the multi-functional marine emergency communications device of the present invention.

U.S. Publication No. 2005/0012563 to AUDREN et al. discloses a system for locating a person having fallen overboard. The system is designed for participants in a race on the open sea. The inventive system is in the form of a clothing article worn by said person having fallen overboard and a receiver module on board the boat. The clothing article comprises a floater forming an upward oriented column when inflated. Additionally, there is provided I the clothing article, a radio transmitter associated with the receiver module and a GPS receiver for determining the position of the person overboard. The GPS receiver and the radio transmitter are arranged in the free end of the column. The GPS position of the person overboard is transmitted to the receiver module by the radio transmitter. The present invention teaches an antenna integrated inside the telescopic pole, which makes the device self-contained and usable by divers, as well as boaters almost anywhere and in any type situation. As such, this prior art publication does not disclose or teach the structure and method of use for the multi-functional marine emergency communications device of the present invention.

U.S. Publication No. 2005/0019101 to SCHMETS discloses a diving aid for diver, comprising a power supply, alarm sound-generating means and activating means for activating the sound-generating means, which activating means are designed in such a way that when the alarm device is in use, said activating means can be activated by an uncontrolled shock load, and that the device comprises means for attaching to the diver's body or the diver's equipment in an unmistakable orientation. This diving aid designed in the form of a wristwatch is strictly an underwater apparatus to communicate with other divers, whereas the present invention, besides having multiple other functions, is not only usable underwater between divers, but also on the surface between divers and boaters, or between divers and the shore, or from boat to boat.

None of the aforementioned prior art patents and prior art publications provide a combination of multiple signaling and survival tools for use in emergency conditions being usable underwater, on the water surface, on the boat, and on the shoreline, either by divers or boaters, in the most varied visibility conditions or storm conditions.

Accordingly, it is an object of the present invention to provide a multi-functional marine emergency communications device that is portable and hand-held for use by scuba divers and boaters when underwater or on the water surface.

Another object of the present invention is to provide a multi-functional marine emergency communications device for communication between divers, boaters and shore personnel during emergency or non-emergency conditions using multiple tools for this communication process.

Another object of the present invention is to provide a multi-functional marine emergency communications device that is a completely self-contained, compact, hand-held portable device which is used by divers and boaters to selectively generate a wide variety of different communication signals adapted to most visibility conditions.

Another object of the present invention is to provide a multi-functional marine emergency communications device that has visual, acoustic, mechanical and electronic tools for communication purposes, whether the use is underwater, on a boat, or on the shoreline in various storm or visibility conditions during an emergency or non-emergency marine situation.

Another object of the present invention is to provide a multi-functional marine emergency communication device that includes a waterproof housing having a plurality of tools such as an acoustical signal generator, a blinking light mechanism, a flashlight, a telescopic pole with a flag, a light-reflecting surface, a GPS transmitter connected to the antenna within the telescoping flag pole, and a retractable cutting tool.

A further object of the present invention is to provide a multi-functional marine emergency communications device that can be mass-produced in an automated and economical manner and is readily affordable by the user.

### SUMMARY OF THE INVENTION

In accordance with the present invention, there is provided a multi-function marine emergency communication device for marine signaling and survival, including a hand-held waterproof housing for holding a plurality of tools, a power source mounted in the housing, and an electronic circuit board mounted in the housing and connected to the power source. A plurality of switches are also mounted in the housing and are connected between the electronic circuit board and the power source. The housing also includes a waterproof spotlight mounted in the housing and a built-in waterproof strobe mounted in the housing, both connected to the electronic circuit board. The housing further includes an acoustical signal generator mounted in the housing and connected to the electronic circuit board, a telescopic pole and flag retractable into the housing and extendable therefrom; a low battery indicator; and a light reflecting surface and a retractable cutting tool.

### BRIEF DESCRIPTION OF THE DRAWINGS

Further objects, features, and advantages of the present invention will become apparent upon the consideration of the following detailed description of the presently preferred embodiment when taken in conjunction with the accompanying drawings, wherein:

FIG. 1 is a front perspective view of the multi-functional marine emergency communications device of the preferred embodiment of the present invention showing a waterproof housing having a retractable telescopic flag pole, a lock, a blinking light, a flashlight, a retractable cutting tool and an acoustical signal generator;

FIG. 2 is a side elevational view of the multi-functional marine emergency communications device of the present invention showing the extended telescopic flag pole;

FIG. 3 is a front perspective view of the multi-functional marine emergency communications device of the present invention showing the acoustical signal generator with its latch in the open position and in an operational mode;

FIG. 4 is a top perspective view of the multi-functional marine emergency communications device of the present invention showing an accessible battery compartment in the waterproof housing;

FIG. 5 is a side perspective view of the multi-functional marine emergency communications device of the present invention showing a handle grip having a light reflective surface and a holding flange for a wrist strap;

FIG. 6 is an exploded perspective view of the multi-functional marine emergency communications device of the present invention showing the major component parts contained herein;

FIG. 7 is a perspective view of the multi-functional marine emergency communications device of the present invention showing the telescopic pole having an interior antenna attached thereto;

FIG. 8 is a rear elevational view of the multi-functional marine emergency communications device of the present invention showing a thumbmark for the retractable cutting tool and a plurality of switches for the various marine signals, and the extended telescopic flag pole;

FIG. 9 is an exploded perspective view of the multi-functional marine emergency communications device of the alternate embodiment of the present invention showing a GPS radio transmitter, a PLB device and an EP/RB device for forming the electronic signaling system of the marine emergency communications device;

FIG. 10 is a schematic electrical diagram of the multi-functional marine emergency communications device of the present invention showing a power source, a circuit board, a low battery indicator, a radio GPS, the antenna and the plurality switches for the various marine signals; and

FIG. 11 is a perspective view of the multi-functional marine emergency communications device of the present invention showing the emergency communication device in an assembled state and in a operational mode by a diver.

### DETAILED DESCRIPTION OF THE PREFERRED EMBODIMENT

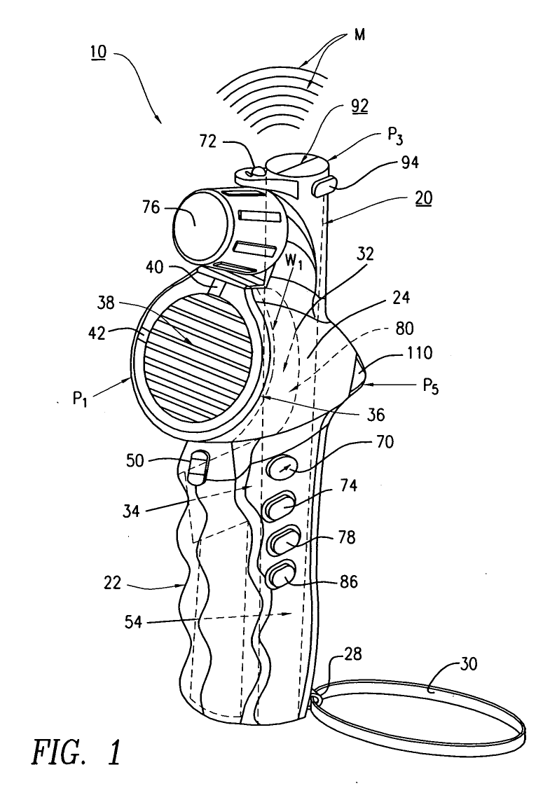

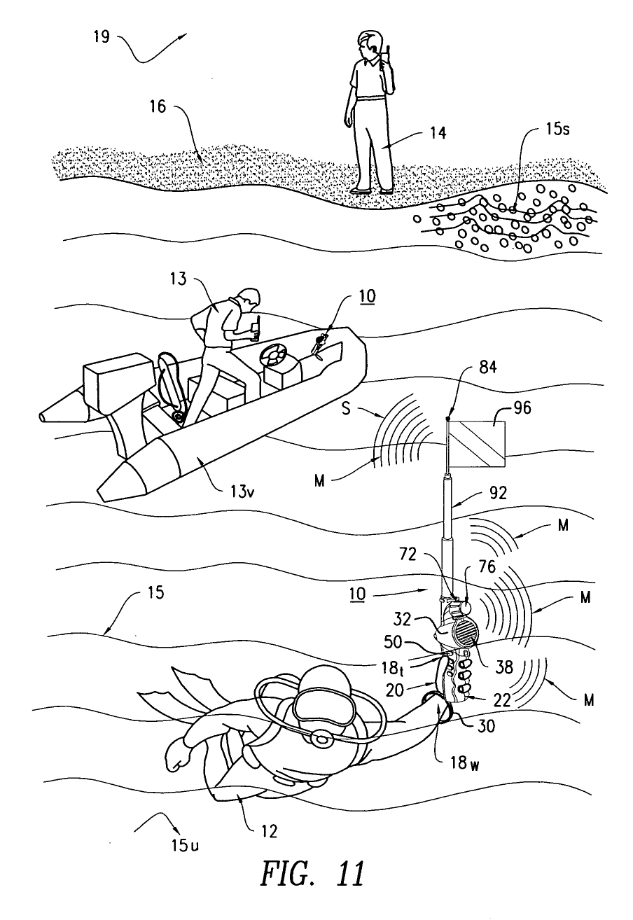

The multi-functional marine emergency communications device 10 and its component parts of the preferred embodiment of the present invention is represented in detail by FIGS. 1 through 8 and 11 on the patent drawings. The multi-functional marine emergency communications device 10 is for use in the communication of divers 12, boaters 13 and users 14 on the shoreline 16 during emergency or non-emergency conditions during storms or limited visibility conditions in ocean or lake waters 15, as depicted in FIG. 11 of the drawings.

As shown in FIGS. 1 through 6, the marine emergency communications device 10 includes a self-contained, compact hand-held, portable and waterproof housing assembly 20. Housing assembly 20 is generally of the size and shape of a hand gun H having a grip 22 and a cup-shaped chamber 24 having an interior wall surface 20. Housing assembly 20 also includes a holding flange 28 for attaching a wrist strap 30 thereto which makes the device easily portable and hand-activated. Housing assembly 20 is preferably constructed of impact-resistant plastic formed by a conventional molding process and sealed to provide a watertight enclosure resistant to the pressures encountered underwater 15u.

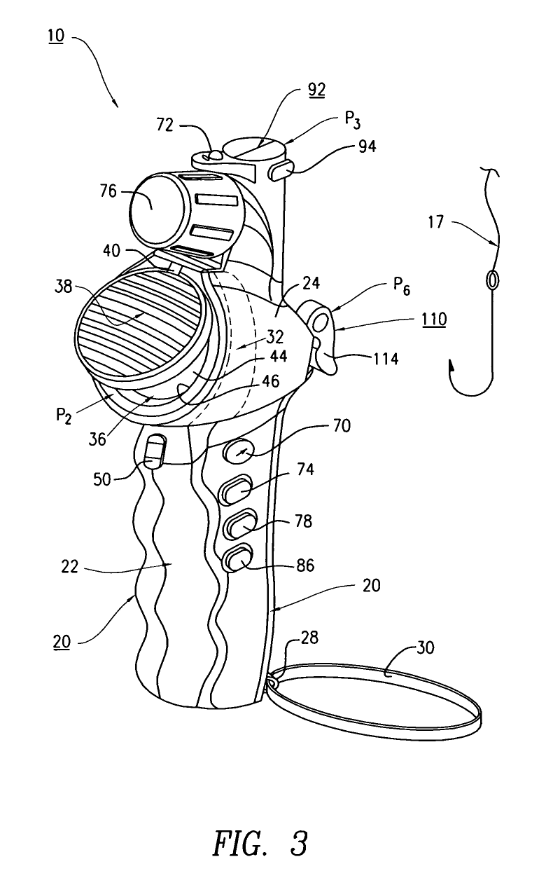

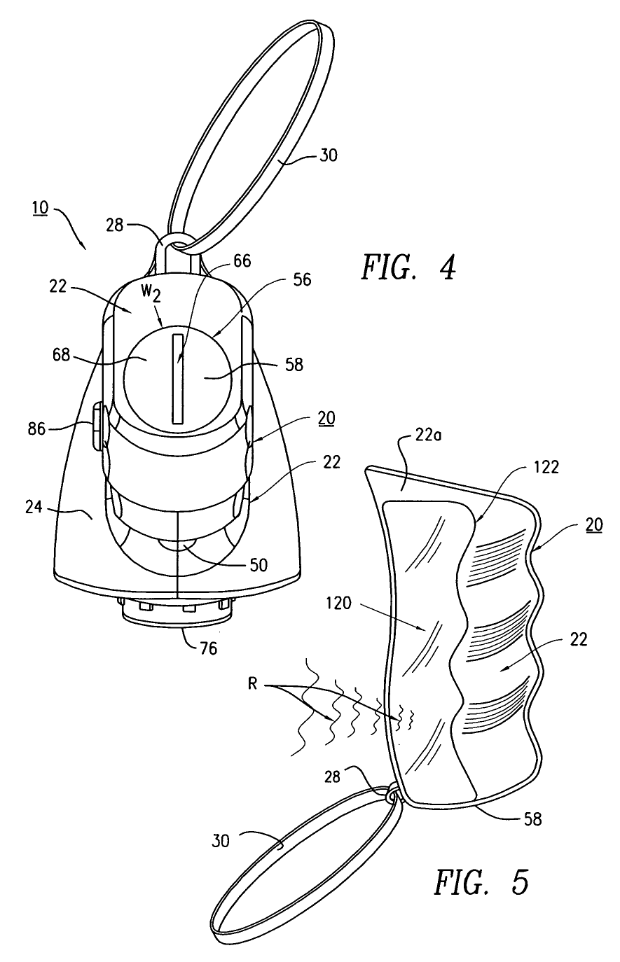

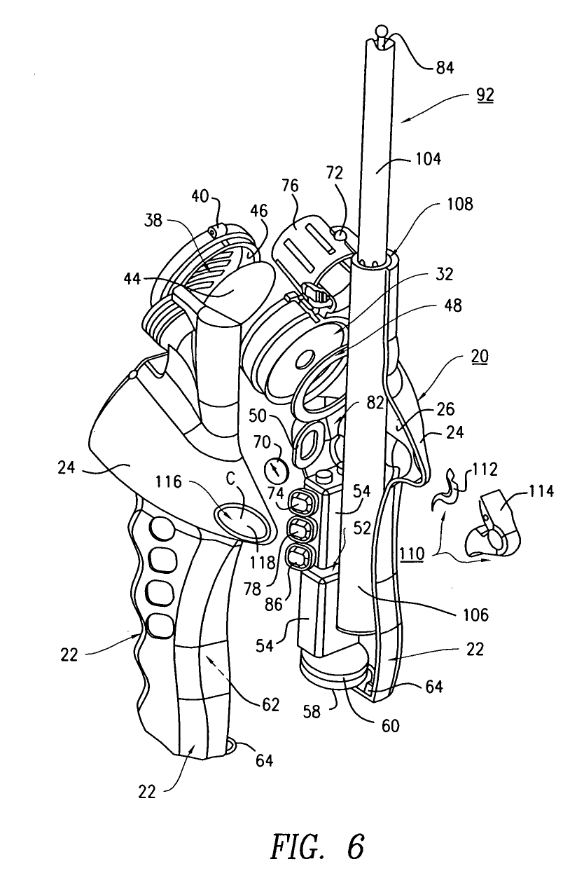

The cup-shaped chamber 24 includes an acoustical signal generator 32 therein, and the acoustical signal generator 32 is connected to an electronic circuit board 34. Housing assembly 20 further includes a front opening 36 for the cup-shaped chamber 24 and the front opening 36 is capped by an end cap 36 which is removably secured to housing assembly 20 by a hinge 40 and a latch 42. As shown in FIGS. 1 and 3, end-cap 38 is in a closed position P₁ and an open position P₂, respectively. End-cap 36 is removably secured to housing assembly 20 by the hinge 40. End-cap 38 is used in the open position P₂ on the water surface 15 and in the closed position P₁ when underwater 15u in order to protect the acoustical signal generator mechanism 32 from excessive water pressure. The front opening 36 of end-cap 38 includes a synthetic membrane 44 being solidly secured within a frame 46 of end-cap 38. End-cap 38 is in the closed position P₁ when the communications device is underwater 15u. Membrane 44 being acoustically transparent, allows an audible output when underwater 15u where sound travels 4 times faster than in the air 19. End-cap 36 is used in the open position P₂ on the water surface 15 for a higher frequency audible output when using the acoustical signal generator 32. The front opening 36 of end-cap 38 includes an O-ring member 48 which fits between the acoustical signal generator 32 and the inside wall surfaces 26 of cup-shaped chamber 24 to form a watertight seal W₁. Additionally, housing assembly 20 includes contact means 50 which is a switch generally in the shape of a trigger for activating the acoustical signal generator 32. A power source 52, as shown in FIG. 6, consists of a pair of 9 volt batteries 54 being located inside grip 22. As shown in FIG. 4, the grip 22 includes an aperture opening 56 having a threaded battery cap 58 therein. The aperture opening 56 includes an O-ring member 60 and an interior recess space 62 for receiving the two 9 volt batteries 54 therein. Aperture opening 56 also includes access to the interior recess space 62 of grip 22, having an interior threaded perimeter 64 for receiving the threaded battery cap 58 in order to engage with aperture opening 56. The battery cap 58 is provided with a longitudinal recessed groove 66 on the outer surface 68 of battery cap 58 in order to allow loosening and tightening of battery cap 58 and aperture opening 56. O-ring member 60, as shown in FIG. 6, fits between battery cap 58 and aperture opening 60 to form a watertight seal W₂. Grip 22 further includes a low battery indicator 70 for checking the power level of the 9 volt batteries 54. Acoustical signal generator 32 is used for calling attention to either underwater divers 12 or to the boater 13, or on the surface shoreline person 14 in order to ask for help in case of emergency.

The waterproof housing assembly 20 further includes a strobe or a blinking light assembly 72 being electrically connected to electronic circuit board 34 and is activated by contact means 74. Strobe 72 is electronically programmed to emit predetermined coded signals by pressing contact means 74 once. The blinking light assembly 72 will emit 60 flashes per minute to indicate position. By pressing contact means 74 twice, blinking light assembly 72 will emit the Morse SOS signal M, 3 shorts, 3 longs, 3 shorts, which is the international distress signal. The electronic circuit board 34 includes an electronic signal system 80. The electronic signal system 80 can be a simple radio transmitter 82 for sending the Morse Code—SOS signal M using an antenna 84.

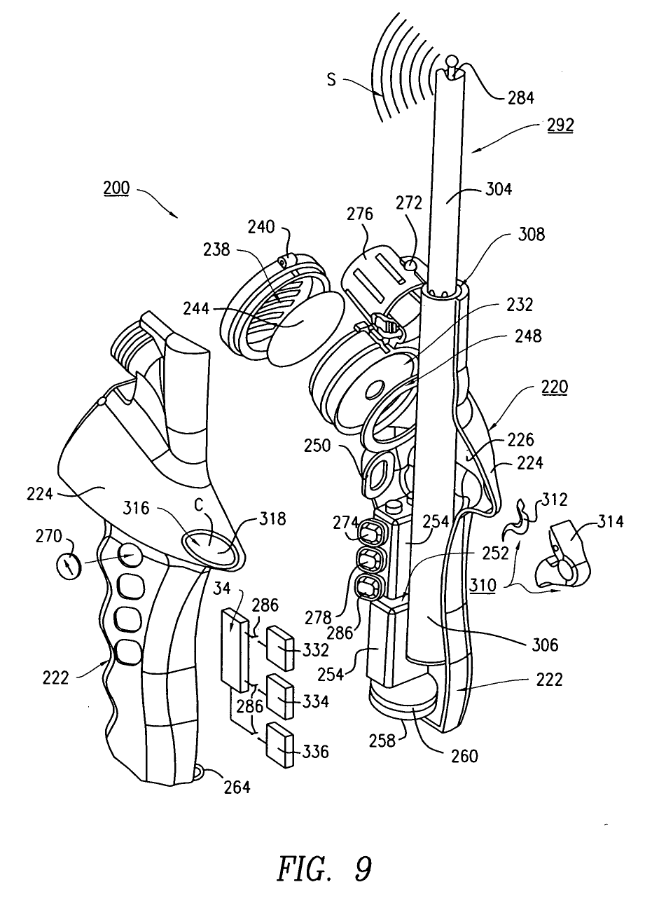

Housing assembly 20 also includes a spotlight 76 being connected to electronic circuit board 34 and is activated by contact means 78 and contact means 78 activates the electronic signal system 80 as shown in FIG. 9. Contact means 50, 74, 78 and 86 are watertight switches connected to power source 52 and are connected to the electronic circuit board 34.

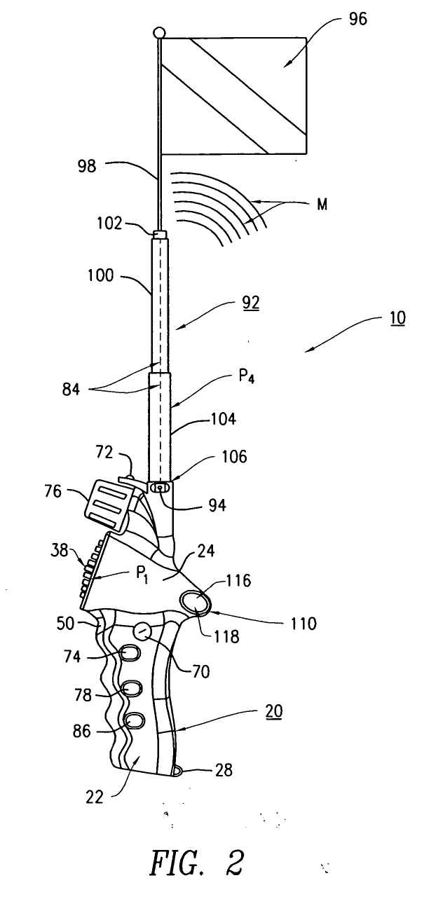

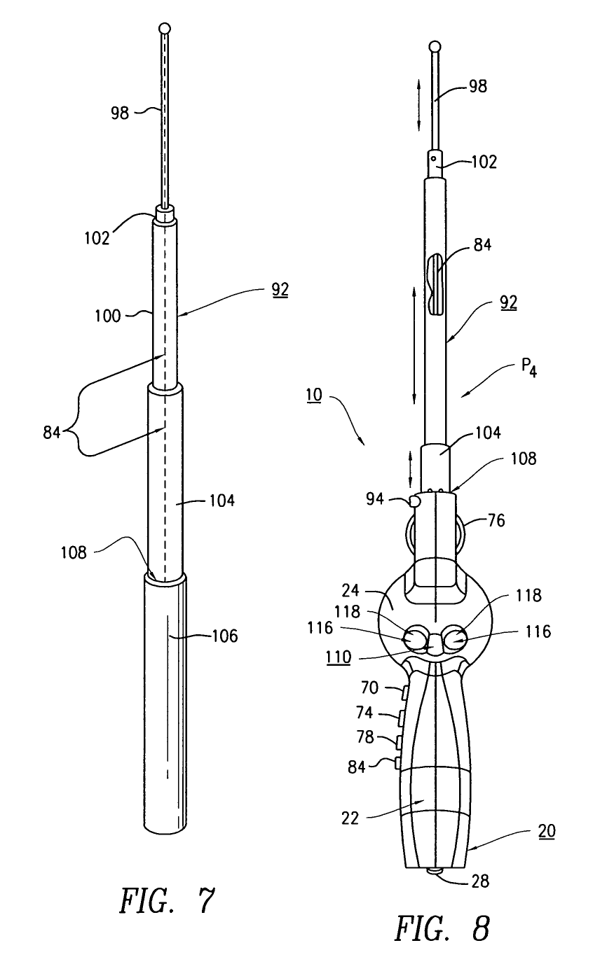

Housing assembly 20 includes a telescopic pole 92 as shown in FIGS. 1, 2 and 7. The telescopic pole 92 is retractable into housing assembly 20 and is secured in that closed position P₃ or released therefrom by a lock 94 to an open position P₄. Telescopic pole 92 supports a marine distress flag 96, as shown in FIG. 2, for visual signaling on the water surface 15 by a drifting diver 12 to ask for help from a vessel 13v or shoreline personnel 14. The marine distress flag 96 can be in a retracted closed position P₃ within housing assembly 20, depicted in FIG. 1. The telescopic flag pole 92 also includes a top pole element 98, a center pole element 100, base member 102 (see FIG. 2) for the top pole element 98, a bottom pole element 104, and an interior hollow pole receiving member 106 having an interior opening 108. As shown in FIGS. 2 and 7, the telescopic pole 92 is in the extended open position P₄ with the top pole element 98 having a much smaller diameter than the center pole element 100. Base member 102 of top pole element 98 is about one inch long and has a wider diameter than top pole element 98. The base member 102 is used to hold the top pole element 98 in place by friction with the preceding center pole element 100. As shown in FIG. 2, the marine distress flag 96 is attached to the top pole element 98 and the flag 96 is shown unfurled. Marine distress flag 96, which is made of brightly colored thin synthetic material, can be rolled around the top pole element 98 and collapsed into the hollow center pole element 100 which, in turn, can retract into the bottom pole element 104 and further retracted into the interior hollow receiving member 106 of housing assembly 20. The telescopic pole 92 in the extended position P₄ with hollow pole elements 100 and 104 contain antenna 84 therein, as shown in FIG. 7. Housing assembly 20 includes the antenna 84 being inserted inside the hollow center pole 100 of telescopic pole 92.

Housing assembly 20 also includes a retractable V-shaped cutting tool 110 shown recessed into the cup-shaped chamber 24, as shown in FIGS. 1, 3, and 6. Cutting tool 110 is shown in an extended position P₆ (see FIG. 3) and includes a cutting blade 112 (as shown in FIG. 6). Cutting blade 112 is inserted inside a V-shaped notch member 114 of cutting tool 110 to protect the user from accidental cutting. By pressing a thumbmark 116, as shown in FIG. 2, the user can extend cutting blade 112 for cutting fishing lines or filaments 17 in case of entanglement. When not in use, cutting tool 110 is retracted to a closed position P₅ into the cup-shaped chamber 24, as shown in FIG. 1 and 2, for safe handling of the device 10 when in an operational mode. Thumbmark 116 of cutting tool 110 has a slight curve C on an upper surface 118 of cup-shaped chamber 24 allowing the easy extension of cutting tool 110 to the open extended position P₆ with an inner movement of a thumb 18t of diver 12. As shown in FIG. 3, the retractable cutting tool 110 is shown in the extended position P₆ for cutting fishing line or filaments 17. As shown in FIG. 6, the cutting blade 112 fits into the V-shaped notch member 114 of retractable cutting tool 110. The V-shaped notch 114 is a guard to prevent accidental cutting. As shown in FIG. 5, the one side 22a of grip 22 includes a light reflecting surface 120 which is a highly-polished plastic mirror being embedded within a recessed interior space 122. Light reflecting surface 120 is used to reflect sun rays R, thus allowing visual signals over long distance when the other signal means are out of range or out of order, as depicted in FIG. 5 of the drawings.

FIG. 9 is an electrical schematic diagram showing the electronic circuit of the present invention, including the low battery indicator 70 .

### ALTERNATE EMBODIMENT 200

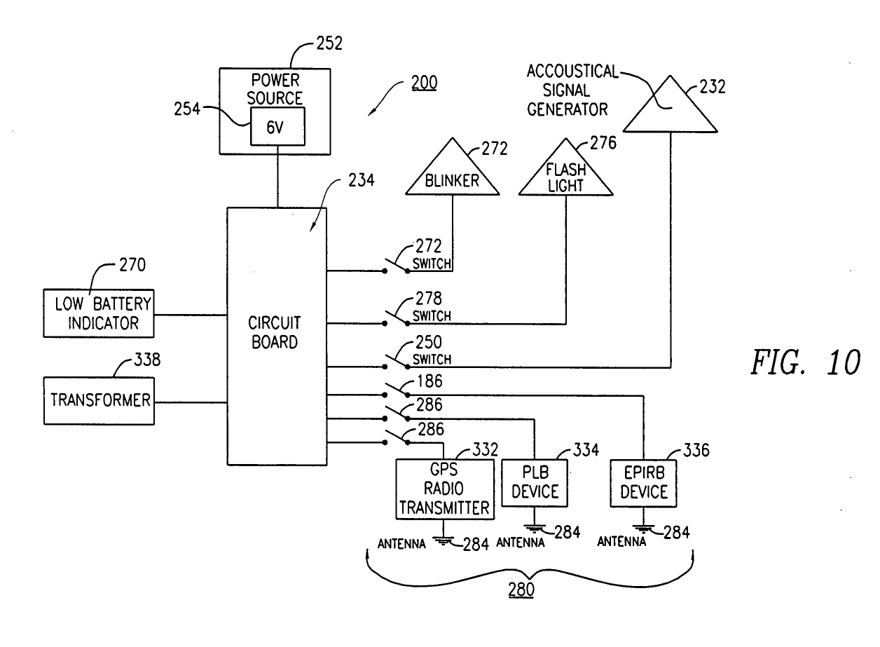

The multi-functional marine emergency communications device 200, and its component parts of the alternate embodiment of the present invention, are represented in detail by FIGS. 9 and 10 of the patent drawings. Elements illustrated in FIGS. 9 and 10, which correspond to the elements described above with reference to FIGS. 1 through 8, have been designated by corresponding reference numbers increased by two hundred. The alternate embodiment 200 is similarly constructed and operates in the same manner as the preferred embodiment 10, unless it is otherwise stated. All aspects of the alternate embodiment of the multi-functional marine emergency communications device 200 are exactly the same as the preferred embodiment of the multi-functional marine emergency communications device 10, except for the additional electronic signaling system devices 280 being activated by contact means 286. These electronic signaling system devices 280 may include at least one or more of such devices within housing assembly 220 being a GPS (Global Positioning System) radio transmitter 332, a PLB (Personal Locating Beacon) device 334, and for an EPIRB (Emergency Position Radio Beacon) device 336 using antenna to transmit the aforementioned electronic signals S from antenna 284 during operational use. The GPS radio transmitter 332 includes a transformer 338 for boosting the electronic signal S from antenna 284, as shown in FIGS. 9 and 10 of the drawings. In all other respects, the marine emergency communications device 100 of the alternate embodiment is exactly the same as the marine emergency communications device 10 of the preferred embodiment except housing assembly 120 receiving a GPS radio transmitter 332, a PLB device 334, and/or an EPIRB device 336 therein.

### OPERATION OF THE PRESENT INVENTION

As shown in FIGS. 1, 2, 9 an 11, the multi-functional marine emergency communications devices 10 and 100 operate in the following manner. The user would initially remove the threaded battery cap 58 and O-ring member 60 of aperture opening 56 for receiving the pair of 9 volt batteries 54 within the recess interior space 62 of grip 22. The user would then re-attach the O-ring member 60 to aperture opening 56 and attach the battery cap 58 to aperture opening 56. The user would now check all switches 50, 74, 78 and 86 for activating the various marine communications devices including the acoustical signal generator 32, the strobe 72, the spotlight 76 and the radio transmitter 82, respectively, to visually see if these devices are in working order. If every device checks out being operational, the marine emergency communication device 10 or 100 is now in an operational mode.

As shown in FIGS. 2 and 11, the diver 12 now attaches the wrist strap 30 on grip 22 to the user's wrist 18w before entering the water 15. While underwater 15u, a diver 12 wishing to draw the attention of another diver triggers acoustical signal generator 32 briefly. If, for example, the diver 12 is in distress, the user triggers acoustic generator 32 repeatedly to emit the Morse SOS emergency signal M, three shorts, three longs, three shorts. Also, if the diver is underwater 15u at night or in bad visibility, the diver 12 presses switch 74 of strobe 72 and leaves it “on” to emit 60 flashes per minute, indicating the user's position. If the diver 12 is in difficulty, he or she presses switch 74 twice to emit the Morse SOS emergency signal M. The diver 12 can use spotlight 76 as backup for his or her primary light when diving at night. Spotlight 76 can be used by boaters 13 or divers 12 as a regular flashlight. Divers 12 or boaters 13 can use cutting tool 110 by extending it out of the housing assembly 20 to cut entangling fishing lines 17.

On the water surface 15, the diver 12 may be drifting with the current and hardly visible in the surf 15s, such that the diver 12 needs to signal the boat 13v or to shore 16 for help. The diver 12 now extends manually the telescopic pole 92, unfurls the marine distress flag 96 and waves the flag to show his or her position. At the same time, the diver 12 then activates the acoustical signal generator 32 to attract additional attention. The diver 12 can also use light reflecting surface 120 on grip 22 to reflect sun signals. In the dark, the diver 12 activates strobe 72 to indicate position or emergency. Alternatively, if the visibility conditions are bad, the diver 12 can use the radio transmitter 82 and antenna 84 to transmit the SOS distress code M via switch 86 from the electronic signal system 80.

If the diver 12 is drifting in the current, and is far and out of sight, using the alternate embodiment 100, the diver 12 presses switch 286 at regular intervals to activate the electronic signaling system 280 indicating his or her geographical position. Electronic signaling system 280 may include one or more of these devices, such as a GPS (Global Positioning System) radio transmitter 332, a PLB (Personal Locating Beacon) device 334, or an EPIRB (Emergency Position Indicating Radio Beacon) device 336 which works in the following manner. The hand-held device 100 would be registered with NOAA (National Oceanic & Atmospheric Administration). If there is trouble (of the life-threatening “send-a-chopper” variety), the boater 13 or diver 12 deploys the telescopic antenna 284 and pushes activation switch 286 to summon help. The unit's GPS locator 332 reads the location and transmits it via satellite to the nearest NOAA ground station. The same method and device can be used on land 16 or on a boat a 13v.

Although the present invention has been described in considerable detail and with reference to certain preferred versions, other versions are possible. For example, while the preferred housing is somewhat gun-shaped with a grip 22, it may also be generally cylindrical with a handle. The telescopic pole 92, which is manual in the preferred version, may be electrically extendable or by spring action. The blinking light assembly 72 may be programmed with various flashing modes or colors. The marine distress flag 96 may include fluorescent “glow-in-the-dark” colors and metal threads visible by radar. Therefore, the spirit and scope of the appended claims should not be limited to the description of the preferred versions disclosed.

Although the present invention has been primarily designed for use in the marine field, it has similar applications in other field of outdoor activities, such as camping and hiking.

### ADVANTAGES OF THE PRESENT INVENTION

Accordingly, an advantage of the present invention is that is provides for a multi-functional marine emergency communications device that is portable and hand-held for use by scuba divers and boaters when underwater or on the water surface

Another advantage of the present invention is that it provides for a multi-functional marine emergency communications device for communication between divers, boaters and shore personnel during emergency or non-emergency conditions using multiple tools for this communication process.

Another advantage of the present invention is that it provides for a multi-functional marine emergency communications device that is a completely self-contained, compact, hand-held portable device which is used by divers and boaters to selectively generate a wide variety of different communication signals adapted to most visibility conditions.

Another advantage of the present invention is that it provides for a multi-functional marine emergency communications device that has visual, acoustic, mechanical and electronic tools for communication purposes, whether the user is underwater, on a boat, or on the shoreline in various storm or visibility conditions during an emergency or non-emergency marine situation.

Another advantage of the present invention is that it provides for a multi-functional marine emergency communications device that includes a waterproof housing having a plurality of tools, such as an acoustical signal generator, a blinking light mechanism, a flashlight, a telescopic pole with a flag, a light reflecting surface, a GPS transmitter connected to the antenna within the telescopic flag poke, and a retractable cutting tool.

A further advantage of the present invention is that it provides for a multi-functional marine emergency communications device that can be mass-produced in an automated and economical manner and is readily affordable by the user.

What is claimed is:

1. A multi-function marine emergency communication device for marine signaling and survival, comprising:
a) a handheld waterproof housing for holding a plurality of tools;
b) a power source mounted in said housing;
c) an electronic circuit board mounted in said housing and connected to said power source;
d) contact means mounted in said housing and connected between said electronic circuit board and said power source;
e) a waterproof spotlight mounted in said housing and connected to the electronic circuit board;
f) a built-in waterproof strobe mounted in said housing and connected to the electronic circuit board;
g) an acoustical signal generator mounted in said housing and connected to said electronic circuit board; and
h) a telescopic pole and flag retractable into said housing and extendable therefrom.

2. A device in accordance with claim 1, wherein said waterproof housing is hollow and generally gun-shaped, with a grip at one end and a cup-shaped chamber extending laterally at the other end.

3. A device in accordance with claim 1, wherein said power source is one or more batteries mounted in an accessible compartment of said housing.

4. A device in accordance with claim 1, wherein said acoustical signal generator is selected from the group consisting of speakers, transducers, buzzers or horns and is mounted in said housing.

5. A device in accordance with claim 4, wherein said acoustical signal generator comprises an end cap removably secured to the housing, said cap including a thin watertight membrane, said membrane being acoustically transparent, thereby allowing operation of said acoustical signal generator in closed position for an audible output underwater and in open position for a high frequency audible output on the surface.

6. A device in accordance with claim 1, wherein said strobe is electronically programmed to emit predetermined coded signals.

7. A device in accordance with claim 1, wherein said electronic circuit board includes an indicator means for indicating when said power source is low.

8. A device in accordance with claim 1, wherein said electronic circuit board includes an electronic signaling system selected from the group consisting of GPS (Global Positioning System), PLB (Personal Locating Beacon), EPIRB (Emergency Position Indicating Radio Beacon) to transmit geographical location.

9. A device in accordance with claim 8, wherein said contact means includes a switch for activating said electronic signaling system.

10. A device in accordance with claim 1, wherein said telescopic pole comprises a plurality of rod elements slidable in and out of one another, said rod elements having each a diameter successively smaller, the rod element at the remote end of the housing being solid and the rest of the rod elements being hollow.

11. A device in accordance with claim 1, wherein said flag is attached to the remote end at the top of the telescopic pole.

12. A device in accordance with claim 1, further including an antenna wire inserted inside the hollow elements of said telescopic pole and connected to said circuit board.

13. A device in accordance with claim 1, further comprising a V shaped cutting tool, said tool being retractable into the housing and extendable thereof.

14. A device in accordance with claim 1, further comprising a light reflecting surface, mounted on an outside wall of said housing, for reflecting sun light signals.

15. A device in accordance with claim 1, wherein said contact means includes a plurality of switches for activating said acoustical signal generator, said spotlight, or said strobe.

16. A multi-function device for marine signaling and survival comprising:
a) a handheld waterproof housing for holding a plurality of tools;
b) a power source mounted in said housing;
c) an electronic circuit board mounted in said housing and connected to said power source;
d) contact means mounted in said housing and connected between said electronic circuit board and said power source;
e) an acoustical signal generator mounted in said housing and connected to said electronic circuit board; and
f) a telescopic pole with flag retractable into said housing and extendable therefrom.

17. A multi-function device for marine signaling and survival comprising:
a) a handheld waterproof housing structured to contain a plurality of tools;
b) a power source mounted in said housing;
c) an electronic circuit board mounted inside said housing and connected to said power source;
d) contact means mounted in said housing and connected between said electronic circuit board and said power source;
e) a waterproof spotlight mounted in said housing and connected to the electronic circuit board;
f) an acoustical signal generator mounted in said housing and connected to said electronic circuit board; and
g) a waterproof strobe mounted in said housing and connected to the electronic circuit board.

18. A multi-function device for marine signaling and survival comprising:
a) a handheld waterproof housing;
b) an acoustical signal generator mounted in said housing and connected to said electronic circuit board;
c) a power source mounted in said housing;
d) an electronic circuit board mounted in said housing and connected to said power source; and
e) contact means mounted in said housing and connected between said electronic circuit board and said power source.

19. A method comprising the steps of using a multi-function device to emit signals underwater, or on the surface comprising the steps of:
a) activating a strobe to indicate position or distress according to predetermined coded signals;
b) activating a spotlight in low visibility to emit coded signals;
c) activating an acoustical signal generator to call attention or signal for rescue;
d) extending a telescopic pole and unfurling a flag to indicate location;
e) sending signals by reflecting sun rays with a light reflecting surface; and
f) activating an electronic signaling system to transmit geographical position.

20. A method in accordance with claim 19, comprising the steps of using a multiple function device for cutting fishing lines or filaments in case of entanglement.
